(19) United States
(12) Patent Application Publication
(10) Pub. No.: US 2013/0321218 A1
(43) Pub. Date: Dec. 5, 2013

(54) WIRELESS COMMUNICATION DEVICE WITH HIGH-GAIN BUILT-IN ANTENNA

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: XIANG CAO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/900,289

(22) Filed: May 22, 2013

(30) Foreign Application Priority Data
May 30, 2012 (CN) 2012202480796

(51) Int. Cl. H01Q 1/24

(52) U.S. Cl. CPC H01Q 1/243
USPC 343/702

(57) ABSTRACT

A wireless communication device includes a main board, a display module, and a coil. The main board includes a feed point and a ground point. The display module comprises a display and a protective panel above the display. The coil is formed on one side of the protective panel serving as a built-in antenna and having two connecting terminals. One correspondingly serves as a feed end by being connected to the feed point and the other end serves as a ground end by being connected the ground point

### BACKGROUND

1. Technical Field

The disclosure generally relates to wireless communication devices, and particularly to a wireless communication device having a built-in antenna.

2. Description of Related Art

To obtain a simple and aesthetic appearance, a wireless communication device such as a mobile phone commonly includes a built-in antenna replacing an external antenna. However, a signal receiving and transmitting gain of the built-in antenna is relative low, and may lead to instability in receiving and transmitting signals so that the mobile phone may easily disconnect from a network.

In addition, due to restrictions of limited space inside the mobile phone, dimensions of the built-in antenna positioned in the mobile phone are also limited which may also restrict a signal receiving and transmitting ability of the mobile phone.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is an exploded view of a wireless communication device, according to an exemplary embodiment of the disclosure.

FIG. 2 is an assembled view of the wireless communication device of FIG. 1.

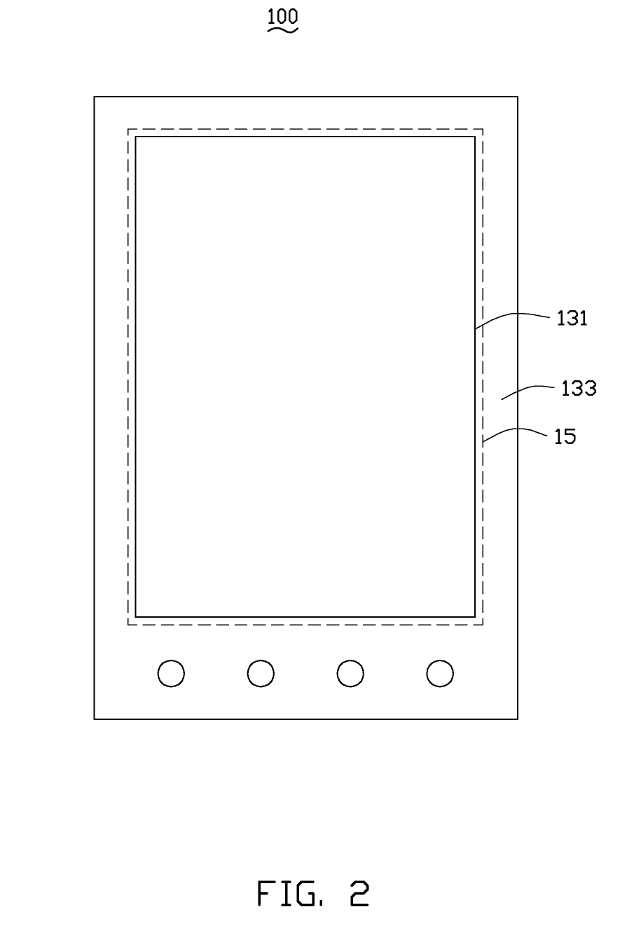

### DETAILED DESCRIPTION

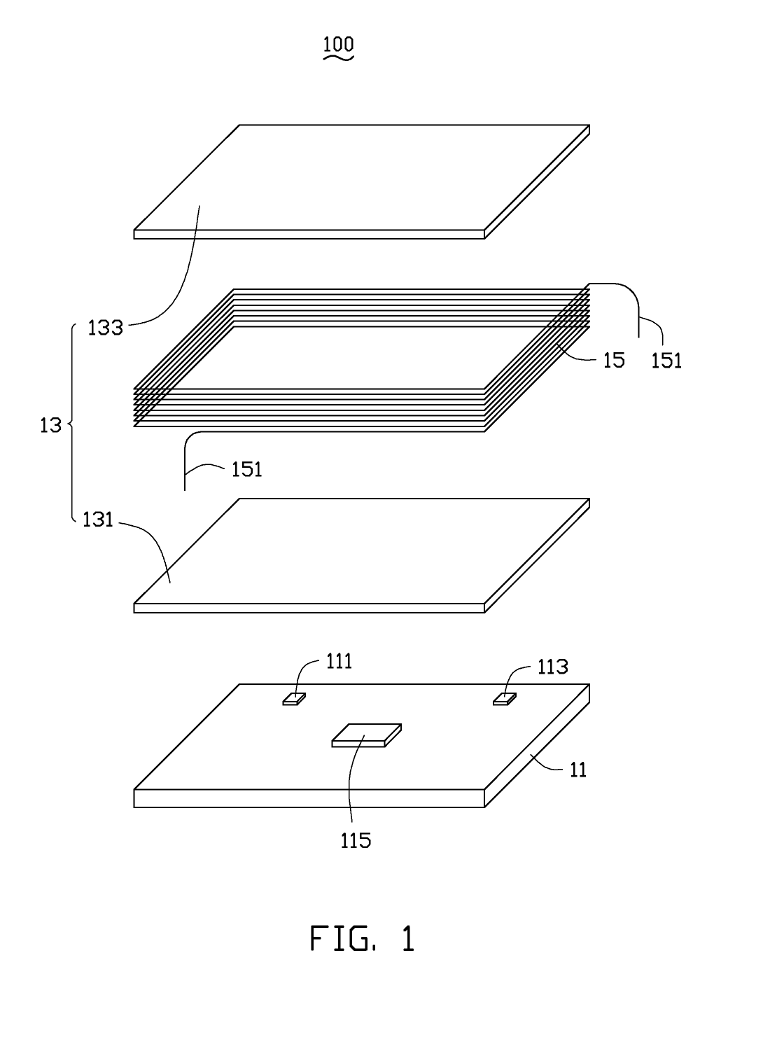

FIG. 1 is an exploded view of a wireless communication device 100, according to an exemplary embodiment of the disclosure. The wireless communication device 100 can be a mobile phone or a personal digital assistant (PDA) or the like. In this exemplary embodiment, the wireless communication device 100 is a mobile phone. The wireless communication device 100 includes a main board 11, a display module 13, and a coil 15.

The main board 11 includes a feed point 111 configured to feed radio frequency signals and a ground point 113 providing ground for the wireless communication device 100. The main board 11 also includes a plurality of elements 115 (schematically shown) such as cameras, keys, and speakers of the wireless communication device 100.

The display module 13 includes a display 131 and a protective panel 133. The protective panel 133 is transparent and may be made of glass. The protective panel 133 is positioned above the display 131 to protect the display 131 from scratches and damage to increase service life of the display 131.

The coil 15 is formed by a metal wire having good conduction performance and includes a plurality of substantially rectangular wire loops 151 wound together. The coil 15 is positioned between the display 131 and the protective panel 133 and serves as a built-in antenna for the wireless communication device 100. The coil 15 includes two connecting terminals 151, one connected to the feed point 111 and the other connected to the ground point 113 and serving as a feed end and a ground end respectively for the built-in antenna.

By changing the number of coils of the coil 15 (i.e. a length of the coil 15) the signal sending/receiving performance of the coil 15 can be adjusted according to various design requirements.

In addition, because the protective panel 133 is transparent, the coil 15 can be designed in color and with style to decorate the protective panel 133. The coil 15 can have an extra decoration function in addition to receiving and transmitting signals as the built-in antenna.

Moreover, because the coil 15 is positioned between the display 131 and the protective panel 133, the coil 15 can be apart from the elements 115 to avoid electromagnetic interference from the elements 115. In one embodiment, shortest distance between the coil 15 and the elements 115 is larger than six millimeters.

In one embodiment, the coil 15 can be directly coiled around a side wall of the display 131 so that the wireless communication device 100 can be further miniaturized.

The wireless communication device 100 using a coiled metal wire as the built-in antenna has a simple structure. The built-in antenna can have large dimensions to ensure a better signal receiving and transmitting ability without occupying any space inside the wireless communication 100.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A wireless communication device, comprising:
a main board comprising a feed point and a ground point;
a display module comprising a display and a protective panel positioned at one side of the display; and
a coil, the coil formed on one side of the protective panel serving as a built-in antenna and having two connecting terminals, one correspondingly serving as a feed end by being connected to the feed point and the other end serving as a ground end by being connected the ground point.

2. The wireless communication device of claim 1, wherein the coil is formed by a metal wire having a plurality of rectangular wire loops wound together.

3. The wireless communication device of claim 1, wherein the protective panel is transparent.

4. The wireless communication device of claim 1, further comprising a plurality of elements positioned on the main board, wherein the coil is apart from the elements.

5. The wireless communication device of claim 4, wherein the distances between the coil and the elements are larger than six millimeters.

6. A wireless communication device, comprising:
a main board comprising a feed point and a ground point;
a display module comprising a display and a protective panel positioned at one side of the display; and
a coil coiled around a side wall of the display to form a built-in antenna having a feed end and a ground end, the feed end and the ground end correspondingly connected to the feed point and the ground point.

7. The wireless communication device of claim 6, wherein the coil is formed by a metal wire having a plurality of rectangular wire loops wound together.

8. The wireless communication device of claim 6, wherein the protective panel is transparent.

9. The wireless communication device of claim 6, further comprising a plurality of elements positioned on the main board, the coil is apart from the elements.

10. The wireless communication device of claim 9, wherein the distances between the coil and the elements are larger than six millimeters.
